(19) United States
(12) Patent Application Publication
(10) Pub. No.: US 2020/0055162 A1
(43) Pub. Date: Feb. 20, 2020

(54) BONDED ABRASIVE ARTICLE INCLUDING A FILLER COMPRISING A NITRIDE

(71) Applicants: SAINT-GOBAIN ABRASIVES, INC., Worcester, MA (US); SAINT-GOBAIN ABRASIFS, Conflans-Sainte-Honorine (FR)

(72) Inventors: Charles J. GASDASKA, Shrewsbury, MA (US); Alexandre TEMPERELLI, Boston, MA (US); Kenneth DUBOVICK, Rutland, MA (US); Rachana UPADHYAY, Shrewsbury, MA (US); Maxime JACQUEMIN, Somerville, MA (US); Srinivasan RAMANATH, Columbia, SC (US); Robin M. BRIGHT, Charlton, MA (US)

(21) Appl. No.: 16/541,980

(22) Filed: Aug. 15, 2019

Related U.S. Application Data
(60) Provisional application No. 62/719,304, filed on Aug. 17, 2018.

(51) Int. Cl. B24B 37/24; C09K 3/14

(52) U.S. Cl. CPC B24B 37/245; C09K 3/1409

(57) ABSTRACT

An abrasive article can include a body including a bond material comprising an inorganic material, abrasive particles and a filler comprising a nitride. The filler comprising a nitride can compensate shrinkage of the body during sintering while maintaining required strength and wear properties of the body.

### CROSS-REFERENCE TO RELATED APPLICATION

This application claims priority under 35 U.S.C. § 119(e) to U.S. Provisional Application No. 62/719,304, entitled “BONDED ABRASIVE ARTICLE INCLUDING A FILLER COMPRISING A NITRIDE,” by Charles J. GASDASKA et al., filed Aug. 17, 2018, which is assigned to the current assignee hereof and is incorporated herein by reference in its entirety.

### BACKGROUND

### Field of the Disclosure

The following is directed to an abrasive article, and particularly, to a bonded abrasive article including a bond material comprising an inorganic material, abrasive particles, and a filler comprising a nitride.

### Description of the Related Art

Bonded abrasive articles typically contain abrasive particles held together by a bond material.

The industry continues to demand improved bonded abrasive articles which have a bond chemistry that provides desired mechanical stability and strength.

### BRIEF DESCRIPTION OF THE DRAWINGS

The present disclosure may be better understood, and its numerous features and advantages made apparent to those skilled in the art by referencing the accompanying drawings.

FIG. 1 includes a flow chart illustrating a process of forming an abrasive article according to an embodiment.

FIG. 2 includes an optical microscope image illustration of a cross section of an abrasive article according to an embodiment.

### DETAILED DESCRIPTION

The following description in combination with the figures is provided to assist in understanding the teachings provided herein. The following disclosure will focus on specific implementations and embodiments of the teachings. This focus is provided to assist in describing the teachings and should not be interpreted as a limitation on the scope or applicability of the teachings. However, other teachings can certainly be used in this application.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent that certain details regarding specific materials and processing acts are not described, such details may include conventional approaches, which may be found in reference books and other sources within the manufacturing arts.

Embodiments disclosed herein are directed to abrasive articles having a body including a bond material comprising an inorganic material, abrasive particles, and a filler comprising a nitride.

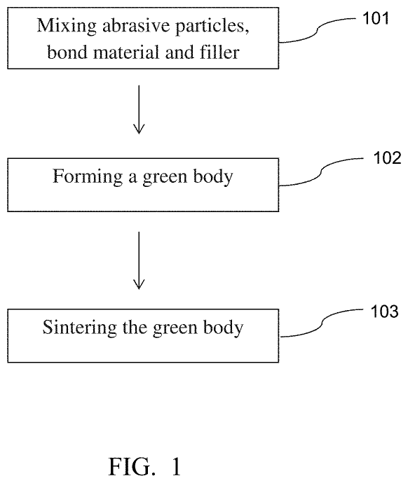

FIG. 1 illustrates a flowchart of a process of forming an abrasive article in accordance to one embodiment. At step 101, a mixture can be formed including an inorganic bond material, a filler including a nitride, and abrasive particles. Suitable mixing operations can be utilized to achieve homogenous dispersion of the components within the mixture.

After forming the mixture (101), a green body can be formed from the mixture (102) having a desired shape. In the next step, the green body may be sintered (103). The sintering can be conducted at a temperature of at least 600° C. to form an abrasive body of suitable strength and density. The selection of the sintering temperature depends, for example, on factors such as the type of bonding material employed, strength, hardness, and/or desired grinding performance. According to a one embodiment, the sintering temperature can be in the range including at least 600° C. to not greater than 1300° C.

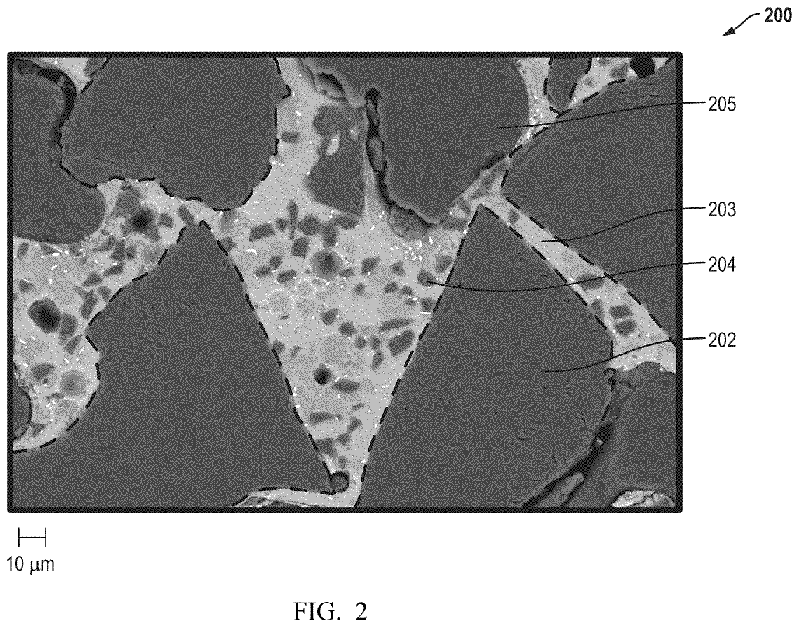

FIG. 2 illustrates a cross section of a body (200) of the abrasive article of the present disclosure according to one embodiment. The body (200) can include abrasive particles (202), a bond material (203), and a filler comprising a nitride (204). In a certain aspect, the body can include pores (205), and in another certain aspect the body can be substantially free of pores.

The body 200 may be incorporated into an abrasive article. It will be appreciated that the body may have any suitable size and shape as known in the art and can be incorporated into various types of abrasive articles to form a bonded abrasive article. For example, the body can be attached to a substrate, such as a hub of a wheel to facilitate formation of a bonded abrasive grinding wheel.

The bond material 203 of the body 200 together with the filler 204 may have a particular bond chemistry that may facilitate improved manufacturing and performance of the abrasive article of the present disclosure.

The abrasive article of the present disclosure can be of particular interest if the body contains an abrasive particle content of less than 50 vol % based on the total volume of the body (but not limited thereto). Abrasive bodies having an abrasive particle content below 50 vol %, for example, for use in cam and crank grinding, can have problems concerning shrinkage and distortion after sintering, which may cause cracking of the body and can be problematic for making abrasive bodies having a complex shape. As further described below, it has been surprisingly discovered that adding a filler comprising a nitride to the abrasive body composition can reduce unwanted shrinkage, while mechanical properties such as strength, wear and hardness can be substantially maintained.

The filler including a nitride 204 contained in the body 200 can be distinct from the abrasive particles 202. In one embodiment, a size ratio (D50F/D50AP) of the average particle size of the filler (D50F) to the average particles size of the abrasive particles (D50AP) can be in a range of at least 0.01 and less than 1. In a particular aspect, the filler-to-abrasive particle ratio (D50F/D50AP) can be at least 0.02, or at least 0.03, or at least 0.04, or at least 0.05, or at least 0.06, or at least 0.07, or at least 0.08, or at least 0.09, or at least 0.1, or at least 0.11, or at least 0.12, or at least 0.13, or at least 0.15, or at least 0.18, or at least 0.2, or at least 0.23, or at least 0.25, or at least 0.28, or at least 0.3, or at least 0.32, or at least 0.35, or at least 0.38, or at least 0.4, or at least 0.5, or at least 0.6, or at least 0.7, or at least 0.8 or at least 0.9. In other aspects, the filler-to-abrasive particle ratio (D50F/D50AP) may be not greater than 0.99, or not greater than 0.98, or not greater than 0.95, or not greater than 0.93, or not greater than 0.9, or not greater than 0.88, or not greater than 0.85, or not greater than 0.83, or not greater than 0.8, or not greater than 0.78, or not greater than 0.75, or not greater than 0.73, or not greater than 0.7, or not greater than 0.68, or not greater than 0.65, or not greater than 0.63, or not greater than 0.6, or not greater than 0.58, or not greater than 0.55, or not greater than 0.53, or not greater than 0.5, or not greater than 0.48, or not greater than 0.45, or not greater than 0.43, or not greater than 0.4, or not greater than 0.38, or not greater than 0.35, or not greater than 0.33, or not greater than 0.3, or not greater than 0.28, or not greater than 0.25, or not greater than 0.23, or not greater than 0.2, or not greater than 0.18, or not greater than 0.15, or not greater than 0.13, or not greater than 0.1, or not greater than 0.08, or not greater than 0.05, or not greater than 0.03. The filler-to-abrasive particle ratio (D50F/D50AP) can be a value between any of the minimum and maximum values noted above. In a particular aspect, the filler-to-abrasive particle ratio (D50F/D50AP) can be from at least 0.01 to not greater than 0.25, or from at least 0.01 to not greater than 0.15.

In another embodiment, the average particle size (D50F) of the filler comprising a nitride (204) can be at least 1 micron, such as at least 2 microns, or at least 3 microns, or at least 4 microns, or at least 5 microns, or at least 6 microns, or at least 7 microns, or at least 8 microns, or at least 9 microns, or at least 10 microns, or at least 12 microns. In another aspect, the average particle size (D50F) may be not greater than 50 microns, such as not greater than 45 microns, not greater than 40 microns, or not greater than 35 microns, or not greater than 30 microns, or not greater than 28 microns, or not greater than 25 microns, or not greater than 22 microns, or not greater than 20 microns, or not greater than 18 microns, or not greater than 15 microns, or not greater than 12 microns, or not greater than 10 microns. The average particle size (D50F) of the filler comprising a nitride can be a value between any of the minimum and maximum values noted above, such as from at least 2 microns to not greater than 50 microns, from at least 3 microns to not greater than 30 microns, or from at least 5 microns to not greater than 15 microns.

In yet another embodiment the particle size distribution of the filler comprising a nitride may be further defined by a D90-D10 range value. The D90 value can represent the particle size value including 90% of the particles sizes in the distribution, such that less than 10% of the particles in the distribution have a size greater than the D90 value. The D10 value can represent a particle size value wherein only 10% of the particles in the distribution are smaller than the D10 particle size value. The D90-D10 range value describes the breadth of the particle size distribution between the D90 and D10 values. According to one embodiment the D90-D10 value range can be at least 1 micron, such as at least 1.5 micron, or at least 2 microns, or at least 3 microns, or at least 5 microns, or at least 7 microns, or at least 10 microns, or at least 12 microns, or at least 15 microns, or at least 20 microns, or at least 25 microns, or at least 30 microns. Still, in another embodiment, the D90-D10 range value can be not greater than 70 microns, such as not greater than 60 microns, or not greater than 50 microns, or not greater than 40 microns. The D90-D10 range value can be within a range including any of the minimum maximum values noted above, including for example, within range of at least 1 micron to not greater than 70 microns, or at least 2 microns to not greater than 30 microns.

In a further embodiment, a content of the filler comprising a nitride can be within a range of at least 1 vol % to not greater than 35 vol % based on a total volume of the bond material and filler. In one aspect, the content of filler can be at least 2 vol %, or at least 3 vol %, or at least 4 vol %, or at least 5 vol %, or at least 6 vol %, or at least 8 vol %, or at least 10 vol %, or at least 12 vol %, or at least 14 vol %, or at least 16 vol %, or at least 18 vol %, or at least 20 vol %, or at least 22 vol %, or at least 25 vol % based on the total volume of bond material and filler. In another aspect, the filler content may be not greater than 30 vol %, or not greater than 28 vol %, or not greater than 25 vol %, or not greater than 22 vol %, or not greater than 20 vol %, or not greater than 18 vol %, or not greater than 16 vol %, or not greater than 14 vol %, or not greater than 12 vol %, or not greater than 10 vol %. The content of filler comprising a nitride in the abrasive body may be within a range including any of the minimum maximum values noted above, such as from at least 2 vol % to not greater than 30 vol %, from at least 5 vol % to not greater than 25 vol %, or from at least 7 vol % to not greater than 20 vol % based on a total volume of bond material and filler.

In a particular embodiment, the filler contained in the body of the abrasive article of the present disclosure can comprise boron nitride. In one aspect, a majority of the filler may comprise boron nitride, for example, at least 55 vol % boron nitride based on a total weight of the filler, or at least 60 vol % boron nitride, or at least 70 vol % boron nitride, or at least 80 vol % boron nitride, or at least 90 vol % boron nitride, or at least 95 vol % boron nitride, or at least 99 vol % boron nitride. In a certain particular aspect, the filler can consist essentially of boron nitride. In yet another certain aspect, all the filler can consist of boron nitride and may only contain unavoidable impurities. An amount of unavoidable impurities may not be greater than 0.1 vol % based on the total weight of the boron nitride filler.

In a particular embodiment, the boron nitride material of the filler can be cubic boron nitride. In one aspect, the filler can comprises at least 50% cubic boron nitride, or at least 60% cubic boron nitride, or at least 70% cubic boron nitride, or at least 80% cubic boron nitride, or at least 90% cubic boron nitride, or at least 95% cubic boron nitride, or at least 99% cubic boron nitride. In a particular aspect, the filler can consist essentially of cubic boron nitride. In yet another certain aspect, all the filler can consist of cubic boron nitride and may only contain unavoidable impurities. An amount of unavoidable impurities in the cubic boron nitride may not be greater than 0.1 vol % based on the total weight of the cubic boron nitride.

The bond material of the body can comprises at least one inorganic material selected from the group consisting of a vitreous material, a metal, a metal alloy, a ceramic, or any combination thereof. In a particular embodiment, the bond material consists essentially of a vitreous material. The bond material consisting essentially of a vitreous material means herein that at least 99 vol % of the bond material are a vitreous material.

The bond material can in addition to the inorganic material include an organic bond material, hereinafter also called organic binder. The organic bond material can assist in forming of the green body by reducing friction during pressing and by providing strength to the green body after pressing. During heat treatment of the green body, the organic bond material may decompose and can create a desired porosity in the sintered body. The organic bond material can be a natural material, a synthetic material, a resin, an epoxy, a thermoset, a thermoplastic, an elastomer, or any combination thereof. In a certain embodiment, the organic binder can include a phenolic resin, an epoxy resin, a polyester resin, a polyurethane, a polyester, a polyimide, a polybenzimidazole, an aromatic polyamide, a modified phenolic resin (such as: epoxy modified and rubber modified resin, or phenolic resin blended with plasticizers), cornstarch, or any combination thereof. In a particular embodiment, the organic material contained in the bond material can include a phenolic resin. In a particular embodiment, the organic bond material can be a wax selected from ZUSOPLAST or CARBOWAX 20M.

In one embodiment, the organic binder can be removed by heat treatment before the sintering (103) and may cause thereby the formation of pores within the body. In one aspect, the debinding can be conducted as a single heat treatment under air at a temperature wherein the binder decomposes, for example at a temperature of 650° C. After the debinding, the sample can be reheated in a non-oxidizing environment, for example under nitrogen, and sintered (103). In another aspect, debinding and sintering can be conducted within one heat treatment regime, wherein the heat treatment is continued after the debinding by further increasing the temperature up to the maximum sintering temperature.

The amount of organic material in the bond material can be at least 1 vol %, or at least 5 vol %, or at least 15 vol % based on the total volume of the bond material. In another aspect, the amount of organic bond material may be not greater than 50 vol %, such as not greater than 40 vol %, or not greater than 30 vol %, or not greater than 25 vol %, or not greater than 20 vol % based on the total volume of the bond material.

In one embodiment, the body of the abrasive article of the present disclosure can have a porosity of at least 1 vol % based on the total volume of the body, or at least 2 vol %, or at least 5 vol %, or at least 8 vol %, or at least 10 vol %, or at least 15 vol %, or at least 20 vol %, or at least 25 vol %, or at least 30 vol %, or at least 35 vol %, or at least 40 vol %, or at least 45 vol %, or at least 50 vol %, or at least 55 vol %, or at least 60 vol %, or at least 65 vol %, or at least 70 vol %, or at least 75 vol %. In a further embodiment, the a porosity of the body may be not greater than 85 vol % for the total volume of the body, or not greater than 80 vol %, or not greater than 75 vol %, or not greater than 70 vol %, or not greater than 65 vol %, or not greater than 60 vol %, or not greater than 55 vol %, or not greater than 50 vol %, or not greater than 45 vol %, or not greater than 40 vol %, or not greater than 35 vol %, or not greater than 30 vol %, or not greater than 25 vol %, or not greater than 20 vol %, or not greater than 15 vol %, or not greater than 10 vol %, or not greater than 5 vol % or not greater than 3 vol %. The porosity of the body can be a value between any of the minimum and maximum values noted above, such as within a range including at least 1 vol % to not greater than 85 vol %, or at least 5 vol % to not greater than 70 vol %, or at least 10 vol % to not greater than 55 vol %. In a particular embodiment, the porosity of the body can be within a range of at least 30 vol % to not greater than 50 vol %.

In yet another embodiment, the body can have an average pore size (D50) of at least 0.5 microns, or at least 1 micron, or at least 5 microns, or at least 10 microns, or at least 15 microns, or at least 20 microns, or at least 30 microns, or at least 40 microns, or at least 50 microns, or at least 60 microns, or at least 80 microns, or at least 90 microns, or at least 100 microns, or at least 120 microns, or at least 140 microns, or at least 160 microns, or at least 180 microns, or at least 200 microns, or at least 220 microns, or at least 240 microns, or at least 260 microns, or at least 280 microns. In a further embodiment, the average pore size (D50) of the body may be not greater than 300 microns, or not greater than 290 microns, or not greater than 280 microns, or not greater than 270 microns, or not greater than 250 microns, or not greater than 230 microns, or not greater than 210 microns, or not greater than 190 microns, or not greater than 170 microns, or not greater than 150 microns, or not greater than 130 microns, or not greater than 110 microns, or not greater than 90 microns, or not greater than 70 microns, or not greater than 50 microns, or not greater than 30 microns, or not greater than 20 microns. The average pore size (D50) can be a value between any of the minimum and maximum values note above, such as within a range including at least 5 microns to not greater than 300 microns, from at least 20 microns to not greater than 200 microns, or at least 30 microns to not greater than 150 microns.

In another embodiment, the body can have a pore size distribution, wherein the distance between the 10th percentile value (D10) of the pore size and the average pore size (D50) may be within a range of at least 3 microns to not greater than 50 microns.

In yet another embodiment, the body can have a pore size distribution, wherein the distance between the 90th percentile value (D90) of the pore size and the average pore size (D50) can be within a range of at least 5 microns to not greater than 80 microns.

In one embodiment, the content of bond material based on the total volume of the body of the abrasive article can be at least 5 vol %, such as at least 10 vol %, or at least 15 vol %, or at least 20 vol %, or at least 25 vol %, or at least 30 vol %, or at least 32 vol %, or at least 35 vol %, or at least 38 vol %, or at least 40 vol %, or at least 42 vol %, or at least 45 vol %, or at least 48 vol %, or at least 50 vol %. In another embodiment, the content of bond material may be not greater than 60 vol % based on the total volume of the body, or not greater than 55 vol %, or not greater than 50 vol %, or not greater than 45 vol %. The content of bond material can be a value between any of the minimum and maximum values noted above, such as from 5 vol % to 60 vol %, or from 20 vol % to 55 vol %, from 35 vol % to 50 vol %, or from 5 vol % to 20 vol % based on a total volume of the body. In a particular embodiment, the bond material can consist essentially of a vitreous material (except for unavoidable impurities), and an amount of the vitreous material may be at least 10 vol % and not greater than 19 vol % based on the total volume of the body.

The abrasive particles contained in the body can comprise a material selected from an oxide, a carbide, a nitride, a boride, diamond, or any combination thereof. In a particular embodiment, the abrasive particles can include boron nitride. In one aspect, the abrasive particles can consist essentially of boron nitride. The boron nitride can be cubic boron nitride (c-BN), or hexagonal boron nitride (h-BN), or amorphous boron nitride (a-BN), or wurtzite boron nitride (w-BN). In a particular aspect, the abrasive particles can consist essentially of cubic boron nitride. Consisting essentially of cubic boron nitride means herein that the abrasive particles may not contain more than 0.5 vol % of a different type of material.

The content of abrasive particles in the body of the present disclosure can be at least 25 vol % based on a total volume of the body, such as at least 30 vol %, or at least 35 vol %, or at least 40 vol %, or at least 45 vol %, or at least 50 vol %. In another embodiment, the content of abrasive particles may be not greater than 80 vol %, such as not greater than 75 vol %, or not greater than 70 vol %, or not greater than 65 vol %, or not greater than 60 vol %, or not greater than 55 vol %, or not greater than 50 vol %, or not greater than 48 vol %, or not greater than 45 vol % based on a total volume of the body. The content of abrasive particles in the body can be a value between any of the minimum and maximum values noted above. In a particular embodiment, the content of abrasive particles can be at least 35 vol % and not greater than 50 vol % based on the total volume of the body.

In one embodiment, the abrasive particles can have an average particle size (D50AP) of at least 40 microns, such as at least 45 microns, at least 50 microns, at least 60 microns, at least 70 microns, at least 80 microns, at least 90, microns, or at least 100 microns, or at least 130 microns, or at least 150 microns, or at least 200 microns, or at least 240 microns. In another embodiment, the average particle size of the abrasive particles (D50AP) may not be greater than 1000 microns, such as not greater than 900 microns, not greater than 800 microns, or not greater than 600 microns, or not greater than 500 microns, or not greater than 400 microns, or not greater than 300 microns. The average particle size of the abrasive particles can be a value between any of the minimum or maximum values noted above, such as from 40 microns to 500 microns, or from 80 microns to 300 microns.

In a certain embodiment, the filler contained in the bond material can include in addition to the nitride at least one other filler material, for example, a metal or a metal alloy (such as nickel, zinc, brass), or an inorganic mineral (such as a carbide, an oxide, or a borate). As used herein, a filler is a particulate material which does not melt together with the bond material during sintering but maintains an independent particle after sintering and can be identified by optical microscopy in the body.

In accordance with another embodiment, the abrasive particles can include unagglomerated abrasive particles, agglomerated abrasive particles, or a combination thereof. In a particular embodiment, a majority of the abrasive particles can be unagglomerated abrasive particles, or more particularly, the abrasive particles can consist essentially of unagglomerated abrasive particles.

In a particular embodiment, the abrasive particles held together by the bond material of the present disclosure can include a coating. The coating of the abrasive particles can include an inorganic material, such as a metal or metal alloy, for example copper, nickel, zinc, brass.

In a further embodiment, a difference of the coefficient of thermal expansion (CTE) between 1) the filler comprising a nitride, 2) the abrasive particles, and 3) the bond material may not differ by more than 1 ppm/° C. In yet another particular embodiment, the filler comprising a nitride and the abrasive particles can have the same CTE.

In one embodiment, the material of the abrasive particle and the material of the filler can be the same. In a particular aspect, the material of the abrasive particles can be cubic boron nitride and the material of the filler can be cubic boron nitride.

In yet a further particular aspect, the material of the abrasive particles can be cubic boron nitride and the material of the filler can be cubic boron nitride, and a ratio of the average particle size of the filler to the average particle size of the abrasive particles (D50F/D50AP) can be from at least 0.01 to not greater than 0.3.

In another particular aspect, the material of the abrasive particles and of the filler can be both cubic boron nitride, and the average particle size of the cubic boron nitride filler may be at least 2 microns and not greater than 30 microns.

In a further particular embodiment, the material of the abrasive particles and of the filler can be both cubic boron nitride, and a content of the filler in the body can be at least 7 vol % and not greater than 30 vol % based on the total volume of the bond material and filler in the body.

In yet another particular embodiment, the body can consist essentially of abrasive particles in an amount of at least 30 vol % and not greater than 50 vol % based on the total volume of the body, a vitreous bond material in an amount of at least 15 vol % and not greater than 30 vol % based on the total volume of the body, and a filler comprising a nitride in an amount of at least 5 vol % and not greater than 35 vol % based on the total volume of bond material and filler, wherein a filler-to-abrasive particle size ratio (D50F/D50AP) is within a range of at least 0.03 and not greater than 0.5, and a porosity of the body is at least 25 vol % and not greater than 45 vol % based on the total volume of the body. In one aspect of this embodiment, the abrasive particles can consist essentially of cubic boron nitride (cBN) and the filler can consist essentially of cubic boron nitride (cBN).

As further demonstrated in the Examples, the filler comprising a nitride can compensate unwanted shrinkage of the abrasive body during sintering, while strength and wear properties can be maintained to a large extent. Not being bound to theory, it is assumed that the filler comprising a nitride can contribute during sintering in forming a strong bond structure between the abrasive particles.

In one aspect, the linear shrinkage reduction after sintering in comparison to the shrinkage of a body not including the filler comprising a nitride of the present disclosure can be at least 10%, such as at least 20%, at least 30% at least 40%, at least 50%, at least 60%, at least 70%, or at least 80%, at least 85%, or at least 90%.

In another aspect, the linear shrinkage of the green body after sintering can be not greater than 5%, such as not greater than 3%, or not greater than 2.5%, or not greater than 2.3%, or not greater than 2.0%, or not greater than 1.8%, or not greater than 1.5%, or not greater than 1.3%, or not greater than 1.0%.

In one aspect, a Rockwell hardness according to ASTM E18 of the body of the present disclosure can be at least 50 HRL, such as at least 60 HRL, at least 70 HRL, at least 80 HRL, at least 90 HRL, at least 95 HRL, at least 100 HRL, or at least 105 HRL. In another aspect, the Rockwell hardness can be not greater than 125 HRL, or not greater than 120 HRL, or not greater than 110 HRL.

In yet a further aspect, the flexural strength of the body can be at least 25 MPa, such as at least 30 MPa, or at least 40 MPa. In another aspect, the strength may be not greater than 100 MPa, or not greater than 90 MPa, or not greater than 80 MPa.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiment 1

An abrasive article comprising: a body including a bond material comprising an inorganic material; abrasive particles having an average particle size (D50AP); a filler comprising a nitride and having an average particle size (D50F); and a filler-to-abrasive particle ratio (D50F/D50AP) within a range of at least 0.01 and less than 0.5.

### Embodiment 2

An abrasive article comprising: a body including a bond material comprising an inorganic material; abrasive particles having an average particle size (D50AP); a filler comprising a nitride and having an average particle size (D50F) within a range of at least 1 micron to not greater than 50 microns.

### Embodiment 3

An abrasive article comprising: a body including a bond material comprising an inorganic material; abrasive particles having an average particle size (D50AP); a filler comprising a nitride, and wherein the body comprises a content of the filler within a range of at least 1 vol % to not greater than 35 vol % for a total volume of the bond material and filler.

### Embodiment 4

An abrasive article comprising: a body including a bond material comprising an inorganic material; abrasive particles having an average particle size (D50AP); a filler comprising a nitride; wherein the body comprises an average wear of not greater than 0.050 cc.

### Embodiment 5

The abrasive article of any one of Embodiments 2, 3, and 4, further comprising a filler-to-abrasive particle ratio (D50F/D50AP) within a range of at least 0.01 and less than 1.

### Embodiment 6

The abrasive article of any one of Embodiments 1 and 5, wherein the filler-to-abrasive particle ratio (D50F/D50AP) is at least 0.02, or at least 0.03, or at least 0.04, or at least 0.05, or at least 0.06, or at least 0.07, or at least 0.08, or at least 0.09, or at least 0.1, or at least 0.11, or at least 0.12, or at least 0.13, or at least 0.15, or at least 0.18, or at least 0.2, or at least 0.23, or at least 0.25, or at least 0.28, or at least 0.3, or at least 0.32, or at least 0.35, or at least 0.38, or at least 0.4 or at least 0.45.

### Embodiment 7

The abrasive article of any one of Embodiments 1 and 5, wherein the filler-to-abrasive particle ratio (D50F/D50AP) is not greater than 0.45, or not greater than 0.40, or than 0.40, or not greater than 0.35, or not greater than 0.33, or not greater than 0.3 or not greater than 0.28, or not greater than 0.25, or not greater than 0.23, or not greater than 0.2, or not greater than 0.18, or not greater than 0.15, or not greater than 0.13, or not greater than 0.1, or not greater than 0.08, or not greater than 0.05, or not greater than 0.03.

### Embodiment 8

The abrasive article of any one of Embodiments 1 and 5, wherein the filler-to-abrasive particle ratio (D50F/D50AP) is within a range of at least 0.01 to not greater than 0.25 or within a range of at least 0.05 to not greater than 0.15.

### Embodiment 9

The abrasive article of any one of Embodiments 1, 3, and 4, wherein the filler comprises a nitride and having an average particle size (D50F) within a range of at least 1 micron to not greater than 50 microns.

### Embodiment 10

The abrasive article of any one of Embodiments 2 and 9, wherein the filler comprises an average particle size (D50F) of not greater than 45 microns or not greater than 40 microns or not greater than 35 microns or not greater than 30 microns or not greater than 28 microns or not greater than 25 microns or not greater than 22 microns or not greater than 20 microns or not greater than 18 microns or not greater than 15 microns or not greater than 12 microns or not greater than 10 microns.

### Embodiment 11

The abrasive article of any one of Embodiments 2 and 9, wherein the filler comprises an average particle size (D50F) of at least 2 microns or at least 3 microns or at least 4 microns or at least 5 microns or at least 6 microns or at least 7 microns or at least 8 microns or at least 9 microns or at least 10 microns or at least 12 microns.

### Embodiment 12

The abrasive article of any one of Embodiments 1, 2, and 4, wherein the body comprises a content of filler within a range of at least 1 vol % to not greater than 35 vol % for a total volume of the bond material and filler.

### Embodiment 13

The abrasive article of any one of Embodiments 3 and 12, wherein the body comprises a content of filler of not greater than 30 vol % based on a total volume of bond material and filler, or not greater than 28 vol %, or not greater than 25 vol %, or not greater than 22 vol %, or not greater than 20 vol %, or not greater than 18 vol %, or not greater than 16 vol %, or not greater than 14 vol %, or not greater than 12 vol % or not greater than 10 vol %.

### Embodiment 14

The abrasive article of any one of Embodiments 3 and 12, wherein the body comprises a content of filler of at least 2 vol % for a total volume of the bond material and filler, or at least 3 vol %, or at least 4 vol %, or at least 5 vol %, or at least 6 vol %, or at least 8 vol %, or at least 10 vol %, or at least 12 vol %, or at least 14 vol %, or at least 16 vol %, or at least 18 vol %, or at least 20 vol %, or at least 22 vol % or at least 25 vol %.

### Embodiment 15

The abrasive article of any one of Embodiments 1, 2, 3, and 4, wherein the filler comprises boron nitride.

### Embodiment 16

The abrasive article of any one of Embodiments 1, 2, 3, and 4, wherein the filler comprises a majority content of boron nitride.

### Embodiment 17

The abrasive article of any one of Embodiments 1, 2, 3, and 4, wherein the filler comprises at least 55 vol % boron nitride for a total weight of the filler, or at least 60 vol % boron nitride, or at least 70 vol % boron nitride, or at least 80 vol % boron nitride, or at least 90 vol % boron nitride, or at least 95 vol % boron nitride, or at least 99 vol % boron nitride.

### Embodiment 18

The abrasive article of any one of Embodiments 1, 2, 3, and 4, wherein the filler consists essentially of boron nitride.

### Embodiment 19

The abrasive article of any one of Embodiments 1, 2, 3, and 4, wherein the filler comprises cubic boron nitride.

### Embodiment 20

The abrasive article of any one of Embodiments 1, 2, 3, and 4, wherein the filler comprises at least 50 vol % cubic boron nitride, or at least 60 vol % cubic boron nitride, or at least 70 vol % cubic boron nitride, or at least 80 vol % cubic boron nitride, or at least 90 vol % cubic boron nitride, or at least 95 vol % cubic boron nitride, or at least 99 vol % cubic boron nitride.

### Embodiment 21

The abrasive article of any one of Embodiments 1, 2, 3, and 4, wherein the filler consists essentially of cubic boron nitride.

### Embodiment 22

The abrasive article of any one of Embodiments 1, 2, 3, and 4, wherein the bond material comprises at least one material selected from a metal, a metal alloy, a ceramic, a vitreous material or any combination thereof.

### Embodiment 23

The abrasive article of Embodiment 22, wherein the bond material consists essentially of a vitreous material.

### Embodiment 24

The abrasive article of any one of Embodiments 1, 2, 3, and 4, wherein the body comprises a content of bond within a range of at least 5 vol % to not greater than 60 vol % for a total volume of the body.

### Embodiment 25

The abrasive article of any of Embodiments 1, 2, 3, and 4, wherein a content of the abrasive particles in the body is at least 25 vol % based on a total volume of the body, such as at least 30 vol %, or at least 35 vol %, or at least 40 vol %, or at least 45 vol %, or at least 50 vol %.

### Embodiment 26

The abrasive article of any of Embodiments 1, 2, 3, and 4, wherein a content of the abrasive particles in the body is not greater than 80 vol % based on the total volume of the body, such as not greater than 70 vol %, or not greater than 65 vol %, or not greater than 60 vol %, or not greater than 55 vol %, or not greater than 50 vol %, or not greater than 45 vol % based on a total volume of the body.

### Embodiment 27

The abrasive article of any one of Embodiments 1, 2, 3, and 4, wherein the abrasive particles comprise a material selected from the group consisting of oxides, carbides, nitrides, borides, diamond, or any combination thereof.

### Embodiment 28

The abrasive article of any one of Embodiments 1, 2, 3, and 4, wherein the abrasive particles comprise boron nitride.

### Embodiment 29

The abrasive article of any one of Embodiments 1, 2, 3, and 4, wherein the abrasive particles consist essentially of boron nitride.

### Embodiment 30

The abrasive article of any one of Embodiments 1, 2, 3, and 4, wherein the abrasive particles consist essentially of cubic boron nitride.

### Embodiment 31

The abrasive article of any one of Embodiment 1, 2, 3, and 4, wherein the abrasive particles comprise a coating comprising an inorganic material.

### Embodiment 32

The abrasive article of any one of Embodiments 1, 2, 3, and 4, wherein the abrasive particles comprise an average particle size particle size (D50AP) within a range of at least 40 microns to not greater than 1000 microns.

### Embodiment 33

The abrasive article of any one of Embodiments 1, 2, 3, and 4, wherein a difference of the coefficient of thermal expansion (CTE) between the filler comprising a nitride, the abrasive particles and the bond material is not greater than 1 ppm/° C., such as not greater than 0.5 ppm/° C., or not greater than 0.1 ppm/° C.

### Embodiment 34

The abrasive article of any one of Embodiments 1, 2, 3, and 4, wherein the body has a Rockwell hardness of at least 50 HRL, such as at least 60 HRL, or at least 70 HRL, or at least 80 HRL, or at least 90 HRL, or at least 100 HRL, or at least 105 HRL.

### Embodiment 35

The abrasive article of any of Embodiments 1, 2, 3, and 4, wherein the body has a Rockwell hardness of and not greater than 125 HRL, not greater than 120 HRL, or not greater than 110 HRL.

### Embodiment 36

The abrasive article of any one of Embodiments 1, 2, 3, and 4, wherein the body has a flexural strength of at least 25 MPa, such as at least 30 MPa, or at least 40 MPa.

### Embodiment 37

The abrasive article of any of Embodiments 1, 2, 3, and 4, wherein the body has a flexural strength of not greater than 100 MPa, or not greater than 90 MPa, or not greater than 80 MPa.

### Embodiment 38

The abrasive article of any one of Embodiments 1, 2, 3, and 4, wherein the body has a porosity of at least 1 vol % based on the total volume of the body, or at least 2 vol %, or at least 5 vol %, or at least 8 vol %, or at least 10 vol %, or at least 15 vol %, or at least 20 vol %, or at least 25 vol %, or at least 30 vol %, or at least 35 vol %, or at least 40 vol %, or at least 45 vol %, or at least 50 vol %, or at least 55 vol %, or at least 60 vol %, or at least 65 vol %, or at least 70 vol %, or at least 75 vol %.

### Embodiment 39

The abrasive article of any one of Embodiments 1, 2, 3, and 4, wherein the body has a porosity of not greater than 85 vol % for the total volume of the body, or not greater than 80 vol %, or not greater than 75 vol %, or not greater than 70 vol %, or not greater than 65 vol %, or not greater than 60 vol %, or not greater than 55 vol %, or not greater than 50 vol %, or not greater than 45 vol %, or not greater than 40 vol %, or not greater than 35 vol %, or not greater than 30 vol %, or not greater than 25 vol %, or not greater than 20 vol %, or not greater than 15 vol %, or not greater than 10 vol %, or not greater than 5 vol % or not greater than 3 vol %.

### Embodiment 40

The abrasive articles of Embodiments 38 or 39, wherein the body has a porosity of at least 30 vol % and not greater than 50 vol %.

### Embodiment 41

The abrasive article of any one of Embodiments 1, 2, 3, and 4, wherein the filler includes cubic boron nitride and the abrasive particles include cubic boron nitride.

### Embodiment 42

The abrasive article of Embodiment 41, wherein an amount of the filler is at least 10 vol % and not greater than 30 vol % based on a total volume of the bond material and filler.

### Embodiment 43

The abrasive article of Embodiment 41, wherein an average particle size of the filler is at least 2 microns and not greater than 30 microns.

### Embodiment 44

The abrasive article of Embodiment 41, wherein a filler-to-abrasive particle ratio (D50F/D50AP) is within a range of at least 0.01 to not greater than 0.3.

### Embodiment 45

The abrasive article of any of Embodiments 1, 2, 3, and 4, wherein the body consists essentially of the abrasive particles in an amount of at least 30 vol % and not greater than 50 vol % based on the total volume of the body; the bond material in an amount of at least 15 vol % and not greater than 30 vol % based on the total volume of the body, and the filler comprising a nitride in an amount of at least 5 vol % and not greater than 35 vol % based on the total volume of the bond material and filler, wherein a filler-to-abrasive particle size ratio (D50F/D50AP) is within a range of at least 0.03 and not greater than 0.5; the bond material is a vitreous bond material; and a porosity of the body is at least 25 vol % and not greater than 45 vol % based on the total volume of the body.

### Embodiment 46

The abrasive article of Embodiment 45, wherein the abrasive particles consist essentially of cubic boron nitride (cBN) and the filler consists essentially of cubic boron nitride (cBN).

### Embodiment 47

The abrasive article of any of Embodiments 1, 2, 3, and 4, wherein a content of the bond material in the body is at least 5 vol % and not greater than 20 vol % based on the total volume of the body.

### Embodiment 48

A method of forming a body of an abrasive article, comprising: preparing a mixture comprising an inorganic bond material, abrasive particles and a filler, wherein the filler comprises a nitride; forming a green body from the mixture; and sintering the green body at a temperature of at least 600° C., wherein a linear shrinkage of the green body after sintering is not greater than 5%.

### Embodiment 49

The method of Embodiment 48, further including debinding of an organic bond material from the green body by heat treatment and before sintering.

### Embodiment 50

The method of Embodiment 48, wherein the linear shrinkage is not greater than 4%, or not greater than 3.0%, or not greater than 2.5%, or not greater than 2.3%, or not greater than 2.0%, or not greater than 1.8%, or not greater than 1.5%, or not greater than 1.3%, or not greater than 1%.

### Embodiment 51

The method of Embodiment 48, wherein the filler comprises cubic boron nitride (cBN).

### Embodiment 52

The method of Embodiment 48, wherein the abrasive particles comprise cubic boron nitride (cBN).

### Embodiment 53

The method of Embodiment 48, wherein a filler-to-abrasive particle ratio (D50F/D50AP) is within a range of at least 0.01 and less than 0.5.

### Embodiment 54

The method of Embodiment 48, wherein an average particle size of the filler is at least 2 microns and not greater than 30 microns.

### Embodiment 55

The method of Embodiment 48, wherein an amount of the filler is at least 5 vol % and not greater than 30 vol % based on a total volume of bond material and filler.

### Embodiment 56

The method of Embodiment 48, wherein a reduction in linear shrinkage of the body in comparison to a body not comprising the filler is at least at least 10%, such as at least 20%, at least 30%, at least 40%, at least 50%, at least 60%, at least 70%, or at least 80%, at least 85%, or at least 90%.

### EXAMPLES

### Example 1

Preparing of Abrasive Bodies

Mixtures were prepared combining in an acoustic mixer abrasive cBN particles, cBN filler, a glass ceramic vitreous bond material (N7 from Saint-Gobain), an organic binder (ZUSOPLAST WE8 from Zschimmer & Schwarz), and water. The mixtures were varied in the average particle size of the cBN abrasive particles, i.e., 53-63 μm (B64); 106-125 μm (B126); and 150-180 μm (B181), the content of the cBN filler (9 vol %, 19 vol %, and 50 vol % based on the total volume of bond material and filler), the amount of the vitreous bond material (14.6 vol %, 13 vol % and 8 vol % based on the total volume of the mixture) to adjust the varying amount of cBN filler, the amount of water (16-24 vol %), and the particle size of the cBN filler (3-5 μm; 6-12 μm; and 12-22 μm), as also summarized in Table 1. All mixtures had the same content of cubic boron nitride abrasive particles of 41 vol % (grit concentration 164) and the same content of organic binder of 15.7 vol % based on the total volume of the mixture.

From each prepared mixture, a green body was formed and subjected to a heat treatment regime in an inert nitrogen atmosphere. The following heat treatment regime was applied: heating under air from 25° C. to 550° C. within 1 hour; maintaining the temperature at 550° C. for 75 minutes; heating from 550° C. to 995° C. within 3 hours; maintaining the temperature at 995° C. for 4 hours; cooling from 995° C. to 550° C. within 2 hours. During the heat treatment, the organic binder decomposed up to a temperature of about 650° C. and the body was sintered at the maximum temperature of 995° C. After completion of the binder burnout, the environment was changed from air to nitrogen.

A summary of the produced sintered bodies by varying the size of the cBN abrasive particles and the size of the cBN filler is shown in Table 1.

TABLE 1

| cBN Abrasive Particles | | | | |
|---|---|---|---|---|
| Grit size | | | cBN Filler | |
| EU | Grit size | Size range | Size range | Size Ratio of |
| FEPA | US ANSI | [μm] | [μm] | Filler/Abrasiveₑ |
| B64 | 230/270 | 53-63 | 3-5 | 0.047-0.094 |
| B126 | 120/140 | 106-125 | 6-12 | 0.048-0.113 |
| B181 | 80/100 | 150-180 | 12-22 | 0.066-0.147 |

### Example 2

To evaluate the influence of the cBN filler on strength, hardness, wear, and shrinkage, experiments were conducted testing body samples prepared according to the method of Example 1 with varying contents of cBN filler and varying particle size of the cBN filler.

Table 2 shows a comparison of sintered bodies formed by the method described in Example 1, with abrasive cBN particles of grit size B126 in an amount of 41 vol % based on the total volume of the body, and varying amounts cBN filler from 0 to 50 vol % based on a total volume of the bond material and filler. The particle size range of the cBN filler was 6-12 microns. It can be seen that an increase in cBN filler of up to 19 vol % caused a reduction in shrinkage combined with only a minor decrease of strength and hardness, and minor increase in wear. However, an increase to 50 vol % cBN filler based on a total volume of bond material and filler caused a large increase in wear which could not be measured by the conducted wear test (see description of wear test below), and the hardness also had a large decline, although the shrinkage further decreased.

TABLE 2

| Amount of cBN | Linear | | | Rockwell |
|---|---|---|---|---|
| filler [vol % of | Shrinkage | Wear | Strength | Hardness |
| bond and filler] | [%] | [cc] | [MPa] | [HRL] |
| 0 | 3.5 | 0.025 | 51.60 | 109.5 |
| 19 | 2.4 | 0.032 | 38.23 | 103.3 |
| 50 | 1.1 | too high | 28.79 | 85.2 |

Table 3 compares shrinkage values of bodies formed using three different sizes of cBN abrasive particles in dependence to an increase in the cBN filler content. The cBN filler particle size was in all experiments 6-12 μm. It can be seen that the presence of a cBN filler in the bodies decreased the linear shrinkage in comparison to bodies which did not include a cBN filler. The shrinkage reduction after sintering by including cBN filler in the body in comparison to the shrinkage of abrasive bodies made without cBN filler was between 21% and 41%, wherein the bodies with the smallest abrasive average particle size (53-63 μm) had the largest percentage reduction in shrinkage.

TABLE 3

| 53-63 μm CBN (B64) | | | 106-125 μm CBN (B126) | | | 150-180 μm CBN (B181) | | |
|---|---|---|---|---|---|---|---|---|
| 6-12 μm CBN filler | | | 6-12 μm CBN filler | | | 6-12 μm CBN filler | | |
| Amount | | Shrinkage | Amount | | Shrinkage | Amount | | Shrinkage |
| of cBN | Shrinkage | reduction | of cBN | Shrinkage | reduction | of cBN | Shrinkage | reduction |
| filler | [%] | to no filler | filler | [%] | to no filler | filler | [%] | to no filler |
| 0 | 3.8 | | 0 | 3.5 | | 0 | 3.7 | |
| 9 | 2.9 | 23.7% | 9 | | | 9 | 2.9 | 21.6% |
| 19 | 2.24 | 41.1% | 19 | 2.4 | 31.4 | 19 | 2.35 | 36.5% |

In case of bodies formed with a smaller size of cBN filler of 3-5 μm, the difference in shrinkage compared to the 6-12 μm cBN filler was only minor (not more than 2% difference in percentage shrinkage reduction). Also the wear of the bodies was very similar comparing bodies made with 3-5 μm cBN filler and 6-12 μm cBN filler.

The linear shrinkage (SL) was determined by measuring the length of the green body (Lgb) and the length of the sintered body (Lsb) and calculated according to the following formula: SL=(Lgb−Lsb/Lgb)×100%.

For the testing of the linear shrinkage, green bodies were prepared by pressing the green body mixture under a pressure of 6 tons in to a mold with a cylindrical shape a dwell time of 10 seconds, the mold having as longest diameter a length of 1.25 inches, and a height of 0.46 inches. The green bodies extracted from the mold were disposed on a ceramic setter plate for debinding and sintering as described in Example 1.

For the testing of the flexural strength, hardness and wear, test bars were prepared using a rectangular mold having a length of 2.64 inches, a width of 0.257 inches, and a height of 0.25 inches. The applied pressure for filling the mold was also 6 tons. After extracting the green body bars from the mold, the bars were subjected to the heat treatment regime described in Example 1 for debinding and sintering.

The measurement of the flexural strength was conducted according to a modified ASTM C1161. ASTM C1161 was modified by with regard to the fixtures span, the bearing diameter and sample size. Testing setup: The Flexural strength was tested by 4-point bending using a semi-articulated fixture with a 2 inch support span (2:1 ratio of support span to load span), 5 mm diameter bearings and a crosshead speed of 0.05 inches/min. The test bars conformed to the requirement that the length is >10 times the thickness of the part to ensure the accuracy of the equations for calculating the bending stress according to ASTM C1161.

The Rockwell Hardness was determined according to ASTM E18.

For the testing of the wear, the test bar was mounted on a support and installed on the specimen holder of a Struers Tegramin-25 grinding and polishing machine. The specimen holder was rotated at 150 rpm and pushed the sample with a constant force of 30 N towards a 120 grit SiC paper, which was counter-rotating at 150 rpm. Each test was conducted for a time period of 10 seconds without using a lubricating fluid.

The wear was determined by measuring the length of the test bar before and after testing, measuring the cross-section of the bar, and calculating the volume of material consumed in one run. The wear tests were repeated for each body type three to five times and an average value was calculated.

### Example 3

Comparative experiments were conducted to evaluate four other filler types in comparison to cubic boron nitride filler: mullite, silicon carbide (SiC), and zirconia (ZrO2).

The comparative abrasive bodies were made according to the method described in Example 1, but by replacing the cBN filler with different filler materials not including a nitrate.

In all comparative experiments, the same amount of filler of 19 vol % based on a total volume of bond material and filler was used. As abrasive particles was used cBN with a particle size range of 106-125 μm (grit size B126) in an amount of 41 vol % based on a total volume of the body.

The abrasive bodies were tested for linear shrinkage, wear, strength and hardness after sintering.

The measured data are summarized in Table 4. It can be seen that although other filler materials can also reduce the shrinkage of the body after sintering, the other tested filler materials had a much larger increase in wear in comparison to bodies containing cBN filler, and had a much larger loss in strength and/or hardness.

TABLE 4

| | Filler Particle | Linear | | Rockwell | |
|---|---|---|---|---|---|
| Filler | Size | Shrinkage | Strength | Hardness | Wear |
| Material | [μm] | [%] | [MPa] | [HRL] | [cc] |
| No filler | | 3.5 | 51.6 | 102.0 | 0.022 |
| cBN | 6-12 | 2.2 | 38.2 | 97.6 | 0.030 |
| Mullite | 3.5 | 2.3 | 36.8 | 90.3 | 0.172 |
| SiC | 10-12 | 2.4 | 27.5 | 96.3 | 0.112 |
| ZrO₂ | 10-20 | 2.2 | 38.5 | 94.3 | 0.086 |

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Reference herein to a material including one or more components may be interpreted to include at least one embodiment wherein the material consists essentially of the one or more components identified. The term “consisting essentially” will be interpreted to include a composition including those materials identified and excluding all other materials except in minority contents (e.g., impurity contents), which do not significantly alter the properties of the material. Additionally, or in the alternative, in certain non-limiting embodiments, any of the compositions identified herein may be essentially free of materials that are not expressly disclosed. The embodiments herein include range of contents for certain components within a material, and it will be appreciated that the contents of the components within a given material total 100%.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An abrasive article comprising:
a body including
a bond material comprising an inorganic material;
abrasive particles having an average particle size (D50_{A}p);
a filler comprising a nitride and having an average particle size (D50p); and
a filler-to-abrasive particle size ratio (D50_{F}/D50_{AP}) within a range of at least 0.01 and less than 0.5.

2. The abrasive article of claim 1, wherein the abrasive particles comprise boron nitride and the filler comprises boron nitride.

3. The abrasive article of claim 2, wherein at least 90 vol % of the abrasive particles based on the total volume of the abrasive particles comprise boron nitride and at least 90 vol % of the filler based on the total volume of the filler comprises boron nitride.

4. The abrasive article of claim 3, wherein the abrasive particles consist essentially of cubic boron nitride and the filler consists essentially of cubic boron nitride.

5. The abrasive article of claim 1, wherein a difference of the coefficient of thermal expansion (CTE) between the filler comprising a nitride, the abrasive particles and the bond material is not greater than 1 ppm/° C.

6. The abrasive article of claim 1, wherein the filler-to-abrasive particle size ratio (D50_{F}/D50_{AP}) is within a range of at least 0.02 and less than 0.3.

7. The abrasive article of claim 1, wherein the filler comprising a nitride has an average particle size (D50_{F}) within a range of at least 1 micron to not greater than 30 microns.

8. The abrasive article of claim 1, wherein an amount of the filler comprising a nitride is within a range of at least 5 vol % and not greater than 30 vol % based on a total volume of bond material and filler.

9. The abrasive article of claim 1, wherein the bond material comprises at least one material selected from a metal, a metal alloy, a ceramic, a vitreous material or any combination thereof.

10. The abrasive article of claim 9, wherein the bond material consists essentially of a vitreous material.

11. The abrasive article of claim 9, wherein a content of the vitreous bond material in the body is at least 5 vol % and not greater than 20 vol % based on the total volume of the body.

12. The abrasive article of claim 1, wherein a content of the abrasive particles in the body is at least 25 vol % and not greater than 50 vol % based on the total volume of the body.

13. The abrasive article of claim 1, wherein the abrasive particles have an average particle size particle size (D50_{AP}) within a range of at least 40 microns to not greater than 1000 microns.

14. The abrasive article of claim 1, wherein the body has a porosity of at least 20 vol % and not greater than 50 vol %.

15. A method of forming a body of an abrasive article, comprising:
preparing a mixture comprising an inorganic bond material, abrasive particles and a filler, wherein the filler comprises a nitride;
forming a green body from the mixture; and
sintering the green body at a temperature of at least 600° C.,
wherein a linear shrinkage of the green body after sintering is not greater than 5%.

16. The method of claim 15, further including debinding of an organic bond material from the green body by heat treatment and before sintering.

17. The method of claim 15, wherein the filler comprises boron nitride and the abrasive particles comprise boron nitride.

18. The method of claim 17, wherein the filler consists essentially of cubic boron nitride (cBN) and the abrasive particles consist essentially of cubic boron nitride (cBN).

19. The method of claim 15, wherein the linear shrinkage is not greater than 3%.

20. The method of claim 15, wherein a filler-to-abrasive particle size ratio (D50_{F}/D50_{AP}) is within a range of at least 0.02 and less than 0.3.
